(19) United States
(12) Patent Application Publication
(10) Pub. No.: US 2014/0226494 A1
(43) Pub. Date: Aug. 14, 2014

(54) APPARATUS AND METHOD FOR PROVIDING SERVICE QUALITY INFORMATION IN AN ELECTRONIC DEVICE

(71) Applicant: Samsung Electronics Co., Ltd, Gyeonggi-do (KR)

(72) Inventors: Hyoung-Il Kim, Gyeonggi-do (KR); Young-Berm Choi, Seoul (KR)

(73) Assignee: Samsung Electronics Co., Ltd, Gyeonggi-do (KR)

(21) Appl. No.: 14/179,407

(22) Filed: Feb. 12, 2014

(30) Foreign Application Priority Data
Feb. 12, 2013 (KR) 10-2013-0014893

(51) Int. Cl. H04L 1/20

(52) U.S. Cl. CPC H04L 1/20
USPC 370/242

(57) ABSTRACT

A method for displaying state information about a service provided to an external output device through short-range wireless communication in an electronic device includes the operations of transmitting image data to an external output device, determining the occurrence or non-occurrence of an error in transmitting the image data, and displaying on a display unit the occurrence or non-occurrence of the error. An electronic device, comprising a communication unit configured to transmit and receive communication signals, a display unit configured to display and at least one processor configured to execute computer programs, wherein the processor is configured to transmit image data to an external output device using the communication system, determine the occurrence or non-occurrence of an error of the image data, and display on the display unit the occurrence or non-occurrence of the error of the image data.

### PRIORITY

The present application is related to and claims priority under 35 U.S.C. §119(a) to a Korean Patent Application No. 10-2013-0014893 filed in the Korean Intellectual Property Office on Feb. 12, 2013, the contents of which are herein incorporated by reference.

### TECHNICAL FIELD

The present disclosure relates to a method for providing service quality information and an electronic device thereof.

### BACKGROUND

With the growth of communication technologies, electronic devices can perform direct communication between the electronic devices without using a communication network such as a base station, a switching center and the like. For example, the electronic devices perform the direct communication between the electronic devices using any one of Infrared Data Association (IrDA), Bluetooth communication, ZigBee, and Wireless Local Area Network (WLAN) communication. Here, the direct communication between the electronic devices can be called short-range wireless communication.

A Wireless Fidelity (WiFi) direct technology, which is a direct communication technology between electronic devices using the WLAN communication, is a short-range wireless communication technology of performing the direct communication between the electronic devices without going through an Access Point (AP). For example, the electronic devices can share image data through a WiFi display service that uses the WiFi direct technology. For example, a 1st electronic device can direct connect with a 2nd electronic device being an external output device and output image data to the external output device, using the WiFi direct technology.

However, when the first electronic device outputs the image data to the second electronic device using the WiFi direct technology, the first electronic device cannot recognize state information about an image that is output from the second electronic device. According to this, there can be a problem in which the first electronic device can output an image in which an error(s) has occurred through the second electronic device.

### SUMMARY

To address the above-discussed deficiencies, it is a primary object to provide an apparatus and method for determining a state of a service provided through short-range wireless communication in an electronic device.

Another aspect of the present disclosure is to provide an apparatus and method for displaying a state of a service provided through short-range wireless communication in an electronic device.

A further aspect of the present disclosure is to provide an apparatus and method for changing a data transmission scheme according to state information about a service provided through short-range wireless communication in an electronic device.

Yet another aspect of the present disclosure is to provide an apparatus and method for feeding back state information about a service provided through short-range wireless communication in an electronic device.

The above aspects are achieved by providing an apparatus and method for providing service quality information in an electronic device.

According to one aspect of the present disclosure, a method for displaying service state information in an electronic device is provided. The method includes the operations of transmitting image data to an external output device, determining the occurrence or non-occurrence of an error(s) of the image data, and displaying on a display unit the occurrence or non-occurrence of the error(s) of the image data.

The operation of determining the occurrence or non-occurrence of the error includes the operations of receiving a feedback signal from the external output device through the communication link, and determining the occurrence or non-occurrence of the error of the image data using the feedback signal.

According to another aspect of the present disclosure, an electronic device includes a communication system for communication, a display unit for displaying, and at least one processor for executing computer programs. The processor transmits image data to an external output device using the communication system, determines the occurrence or non-occurrence of an error(s) of the image data, and displays on the display unit the occurrence or non-occurrence of the error of the image data.

The processor determines the occurrence or non-occurrence of the error of the image data, in a feedback signal received from the external output device through the communication link.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates transmitting data to an external output device in an electronic device according to embodiments of the present disclosure;

FIG. 2 is a high-level block diagram of an electronic device according to embodiments of the present disclosure;

FIG. 3 is a high-level block diagram of a processor according to embodiments of the present disclosure;

FIG. 4 is a flowchart illustrating a procedure for determining service state information in an electronic device according to embodiments of the present disclosure;

FIG. 5 is a flowchart illustrating a procedure for feeding back service state information in an external output device according to embodiments of the present disclosure;

FIG. 6 is a flowchart illustrating a procedure for displaying service state information in an electronic device according to embodiments of the present disclosure;

FIG. 7 is a flowchart illustrating a detailed procedure for displaying service state information in an electronic device according to embodiments of the present disclosure;

FIG. 8 is a flowchart illustrating a procedure for improving a service quality in an electronic device according to embodiments of the present disclosure; and

FIGS. 9A to 9D are diagrams illustrating example screens displaying service state information in an electronic device according to embodiments of the present disclosure.

### DETAILED DESCRIPTION

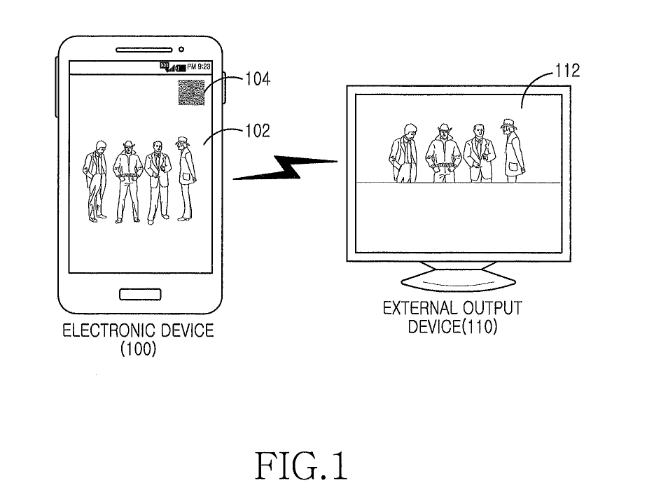

FIGS. 1 through 9D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined on the basis of the disclosure throughout this specification.

The present disclosure relates to a method for providing quality information about a service transmitted to an external output device and an electronic device thereof.

Below, the present disclosure describes a technology for displaying state information about a service provided to an external output device through short-range wireless communication in an electronic device.

In the following description, the electronic device can include one or more of a mobile communication terminal supporting short-range wireless communication, a Personal Digital Assistant (PDA), a Personal Computer (PC), a laptop computer, a smartphone, a netbook, a Mobile Internet Device (MID), an Ultra Mobile PC (UMPC), a tablet PC, a navigator, and an MPEG audio layer 3 (MP3).

Also, the external output device includes a mobile communication terminal supporting short-range wireless communication with the electronic device, a PDA, a PC, a laptop computer, a smartphone, a netbook, a television, an MID, a UMPC, a tablet PC, a navigator, and an MP3.

In the following description, it is assumed that the electronic device outputs image data to the external output device through short-range wireless communication that uses radio resources. Here, the image data includes one or more of a video, a photo, and a picture.

FIG. 1 illustrates a construction for transmitting data to an external output device in an electronic device according to embodiments of the present disclosure.

As illustrated in FIG. 1, the electronic device 100 performs communication with the external output device 110 through short-range wireless communication that uses radio resources. For example, the electronic device 100 transmits image data to the external output device 110 through the short-range wireless communication. At this time, the electronic device 100 can display on a display unit 102 of the electronic device 100 the image data transmitted to the external output device 110.

The external output device 110 outputs through a display unit 112 of the external output device 110 the image data received from the electronic device 100. At this time, the external output device 110 transmits service state information about the image data received from the electronic device 100, to the electronic device 100. Here, the service state information can include the occurrence or non-occurrence of an error of the image data received from the electronic device 100.

The electronic device 100 displays the service state information 104 received from the external output device 110, in a partial region of the display unit 102.

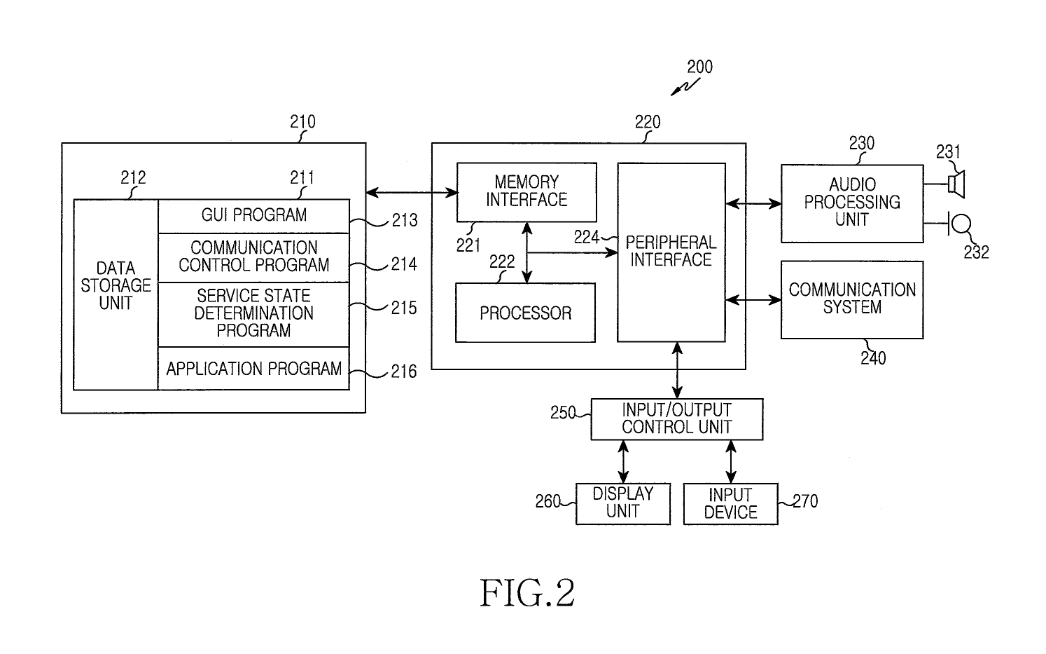

FIG. 2 is a block diagram illustrating a construction of an electronic device according to embodiments of the present disclosure.

As illustrated in FIG. 2, the electronic device 200 includes a memory 210 a processor unit 220, an audio processing unit 230, a communication system 240, an input/output control unit 250, a display unit 260, and an input device 270. Here, the memory 210 can exist in plural.

The memory 210 includes a program storage unit 211 storing a program for controlling the operation of the electronic device 200 and a data storage unit 212 storing data which are generated during program execution. For example, the data storage unit 212 stores information of a plurality of data transmission schemes which are used for transmitting image data to an external output device. Here, the data transmission scheme includes a scaling scheme for the image data that will be transmitted to the external output device.

The program storage unit 211 includes a Graphical User Interface (GUI) program 213, a communication control program 214, a service state determination program 215, and at least one application program 216. Here, the program included in the program storage unit 211, a set of instructions, can be expressed as an instruction set.

The GUI program 213 includes at least one software constituent element for providing a graphical user interface to the display unit 260. For example, the GUI program 213 includes an instruction of displaying on the display unit 260 information of an application program driven by the processor 222. At this time, the GUI program 213 can control the display unit 260 to display information of a service state determined through the service state determination program 215.

The communication control program 214 includes at least one software constituent element for controlling short-range wireless communication with at least one external output device that uses the communication system 240. For example, the communication control program 214 searches an external output device for short-range wireless communication connection. If the external output device for the short-range wireless communication connection is searched, the communication control program 214 establishes the short-range wireless communication connection with the external output device. After that, the communication control program 214 controls to perform a performance search and session establishment procedure with the external output device with which the connection is established, and transmit/receive data with the external output device through the communication system 240.

Also, according to an image transmission scheme change event, the communication control program 214 controls to change a data transmission scheme of transmitting image data to an external output device. For example, if the service state determination program 215 determines that an error is included in the image data transmitted to the external output device, the communication control program 214 can change the data transmission scheme considering the data transmission schemes stored in the data storage unit 212, in accordance with input information received from the input device 270. That is, if the change of the data transmission scheme according to the input information received from the input device 270 is determined, the communication control program 214 can change the data transmission scheme considering the data transmission schemes stored in the data storage unit 212.

The service state determination program 215 includes at least one software constituent element for determining a state of a service provided to an external output device that performs short-range wireless communication through the communication system 240. For example, the service state determination program 215 determines a state of a service provided to the external output device, by means of service state information received from the external output device through the communication system 240.

The application program 216 includes a software constituent element for at least one application program installed in the electronic device 200.

The processor unit 220 includes a memory interface 221, at least one processor 222, and a peripheral interface 224. Here, the memory interface 221, at least one processor 222, and peripheral interface 224 included in the processor unit 220 can be integrated as at least one integrated circuit or be implemented as separate constituent elements.

The memory interface 221 controls the access of a constituent element such as the processor 222 or the peripheral interface 224, to the memory 210.

The peripheral interface 224 controls the connection of the memory interface 221 and the processor 222 with an input/output peripheral device of the electronic device 200.

The processor 222 controls the electronic device 200 to provide various multimedia services using at least one software program. At this time, the processor 222 executes at least one program stored in the memory 210 and provides a service corresponding to the corresponding program. For example, the processor 222 can execute one or more of the GUI program 213, the communication control program 214, and the service state determination program 215 which are stored in the program storage unit 211, and determine short-range wireless service state information with an external output device.

The audio processing unit 230 provides an audio interface between a user and the electronic device 200 through a speaker 231 and a microphone 232.

The communication system 240 performs a function of short-range wireless communication. For example, the communication system 240 performs direct communication with an external output device using any one of Infrared Data Association (IrDA), Bluetooth communication, and WLAN communication.

The input/output control unit 250 provides an interface between an input/output device such as the display unit 260, the input device 270 and the like, and the peripheral interface 224.

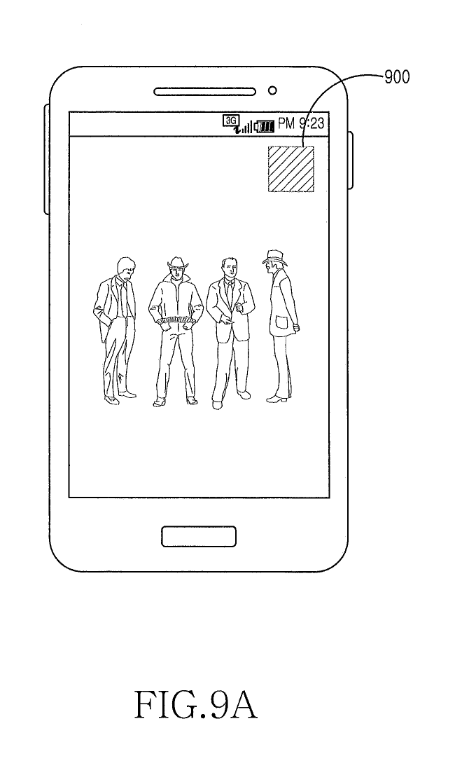

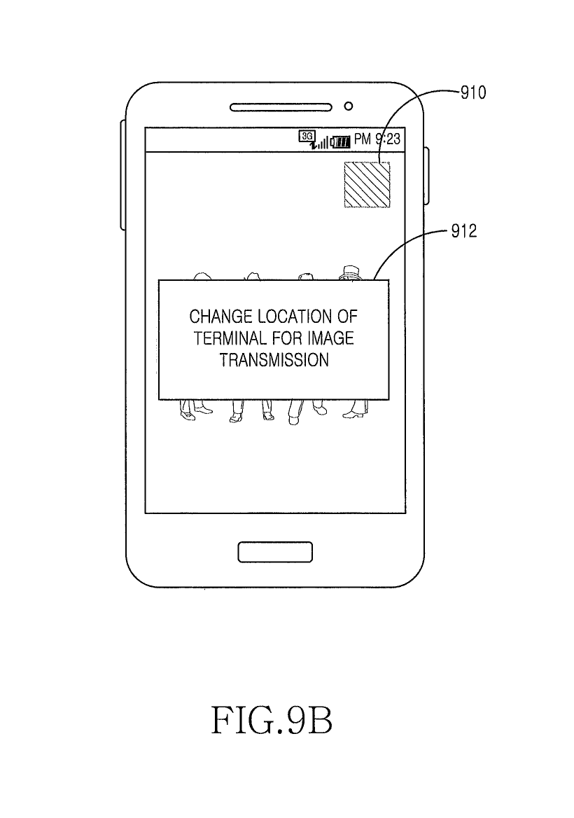

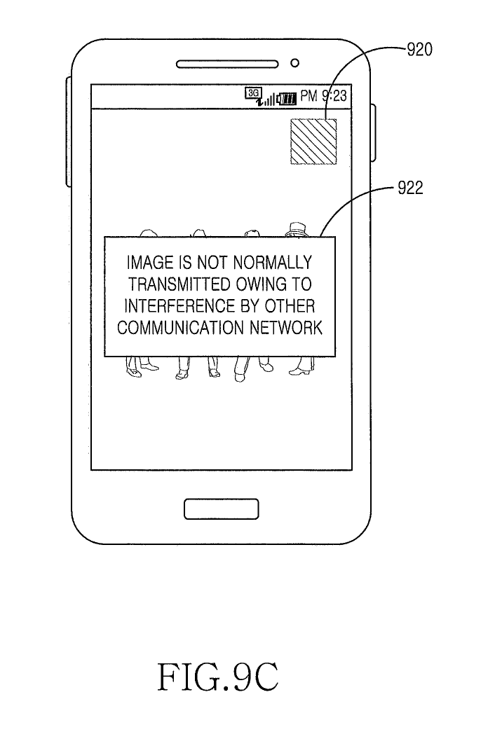

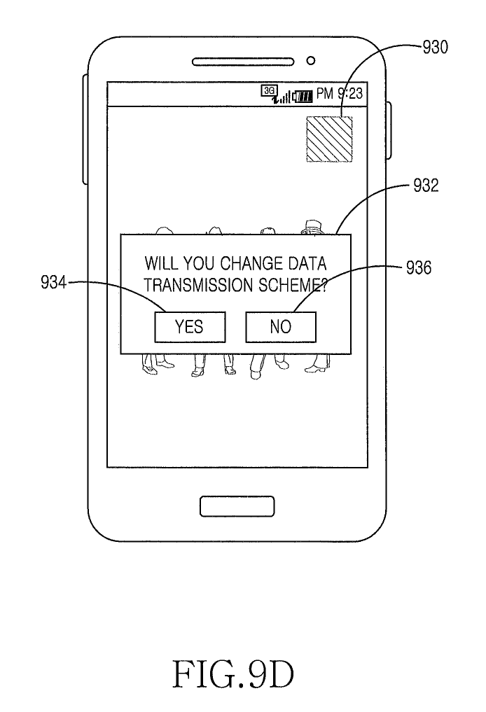

The display unit 260 displays state information of the electronic device 200, a character input by a user, a moving picture, a still picture, and the like. For example, the display unit 260 displays information of an application program driven by the processor 222. If the electronic device 200 transmits image data to an external output device through the communication system 240, the display unit 260 displays a state of a service provided to the external output device, determined through the service state determination program 215. For example, as illustrated in FIG. 9A, the display unit 260 displays state information 900 of a service provided to the external output device, in a partial region of a service screen. If an error is included in the image data transmitted to the external output device, as illustrated in FIG. 9B or 9C, the display unit 260 can display error state information 912 and 922, together with service state information 910 and 920.

The input device 270 provides input data generated by user's selection, to the processor unit 220 through the input/output control unit 250. In the embodiment, the input device 270 includes a keypad including at least one hardware button, a touch pad sensing touch information, and the like.

In the aforementioned embodiment, the processor 222 can execute software constituent elements stored in the program storage unit 211 and determine short-range wireless service state information with an external output device, within one module.

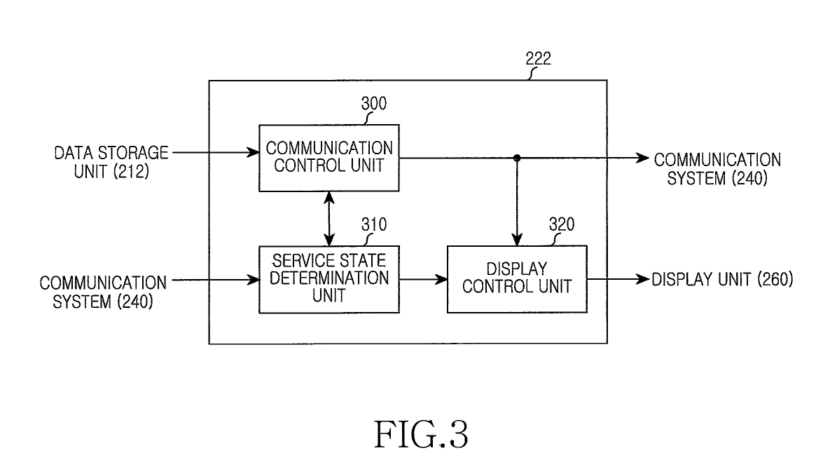

In another embodiment, the processor 222 can include constituent elements for determining short-range wireless service state information with an external output device, as separate modules, as in FIG. 3 below.

FIG. 3 is a detailed block diagram illustrating a construction of a processor according to embodiments of the present disclosure.

As illustrated in FIG. 3, the processor 222 includes a communication control unit 300, a service state determination unit 310, and a display control unit 320.

The communication control unit 300 executes the communication control program 214 stored in the program storage unit 211 and controls short-range wireless communication with at least one external output device that uses the communication system 240. For example, the communication control unit 300 searches an external output device for short-range wireless communication connection. If the external output device for the short-range wireless communication connection is searched, the communication control unit 300 establishes the short-range wireless communication connection with the external output device. After that, the communication control unit 300 controls to perform a performance search and session establishment procedure with the external output device with which the connection is established, and transmit/receive data with the external output device through the communication system 240.

Also, according to an image transmission scheme change event, the communication control unit 300 controls to change a data transmission scheme of transmitting image data to an external output device. For example, if the service state determination unit 310 determines that an error is included in the image data transmitted to the external output device, the communication control unit 300 can change the data transmission scheme considering the data transmission schemes stored in the data storage unit 212, in accordance with input information received from the input device 270. That is, if the change of the data transmission scheme according to the input information received from the input device 270 is determined, the communication control unit 300 can change the data transmission scheme considering the data transmission schemes stored in the data storage unit 212.

The service state determination unit 310 includes at least one software constituent element for determining a state of a service provided to an external output device that performs short-range wireless communication through the communication system 240. For example, the service state determination unit 310 determines a state of a service provided to the external output device, by means of service state information received from the external output device through the communication system 240.

The display control unit 320 executes the GUI program 213 stored in the program storage unit 211 and provides a graphical user interface to the display unit 260. For example, the display control unit 320 controls to display on the display unit 260 information of an application program driven by the processor 222. At this time, the display control unit 320 controls to display on the display unit 260 information of a service state determined through the service state determination unit 310.

According to control of the display control unit 320, as illustrated in FIG. 9A, the display unit 260 displays state information 900 of a service provided to an external output device, in a partial region of a service screen. If an error(s) is included in image data transmitted to the external output device, as illustrated in FIG. 9B or FIG. 9C, the display unit 260 can display error state information 912 and 922 together with service state information 910 and 920.

In the aforementioned embodiment, the electronic device 200 includes the communication control unit 300 and the service state determination unit 310, and determines short-range wireless service state information with an external output device using the processor 222.

In another embodiment, the electronic device 200 can include a separate control module for controlling to determine short-range wireless service state information with an external output device.

The external output device performing short-range wireless communication with the electronic device 200 constructed as described above can have the same construction as the electronic device 200 of FIG. 2 and the processor 222 illustrated in FIG. 3. A service state determination unit of the external output device executes a service state determination program stored in a program storage unit of the external output device, and determines the occurrence or non-occurrence of an error(s) of image data received from the electronic device 200. For example, the service state determination unit of the external output device determines the occurrence or non-occurrence of the error(s) in consideration of a Cyclic Redundancy Check (CRC) of the image data received from the electronic device 200.

A communication control unit of the external output device executes a communication control program stored in the program storage unit of the external output device, and controls short-range wireless communication with the electronic device 200. At this time, the communication control unit of the external output device transmits to the electronic device 200 information of a service state determined in the service state determination unit of the external output device. For example, the communication control unit of the external output device transmits service state information about each frame to the electronic device 200, using an extension region of the Real-time Transport Protocol (RTP) standard.

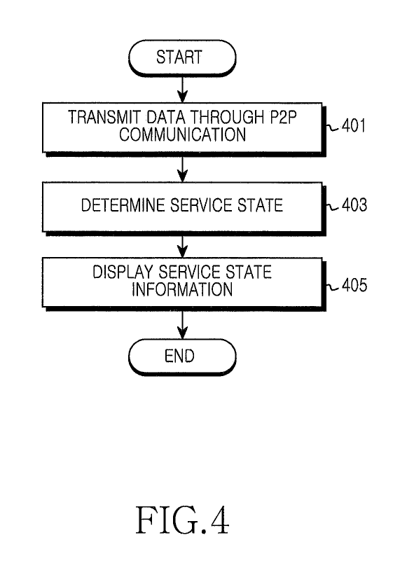

FIG. 4 illustrates a procedure for determining service state information in an electronic device according to embodiments of the present disclosure.

Referring to FIG. 4, in step 401, the electronic device transmits image data to an external output device through short-range wireless communication. For example, the electronic device searches an external output device for short-range wireless communication connection. If the external output device for the short-range wireless communication connection is searched, the electronic device establishes the short-range wireless communication connection with the external output device. After that, after performing a performance search and session establishment procedure with the external output device with which the connection is established, the electronic device transmits image data to the external output device.

After that, the electronic device proceeds to step 403 and determines state information about a service that is provided to the external output deice through the short-range wireless communication. For example, the electronic device determines the occurrence or non-occurrence of an error of the image data transmitted to the external output device, by means of the service state information received from the external output device.

After determining the state information about the service provided to the external output device, the electronic device proceeds to step 405 and displays the service state information on a display unit. For example, if an error does not occur in the image data transmitted to the external output device, as illustrated in FIG. 9A, the electronic device displays normal service state information 900 in a partial region of a service screen. For another example, if the error occurs in the image data transmitted to the external output device, as illustrated in FIG. 9B, the electronic device can display service error information 910 and guidance information 912 for error improvement. For further example, if an error by interference occurs in the image data transmitted to the external output device, as illustrated in FIG. 9C, the electronic device can display service error information 920 and guidance information 922 for error improvement.

The electronic device repeatedly performs the aforementioned operations (steps 401 to 405) until the short-range wireless communication with the external output device is ended.

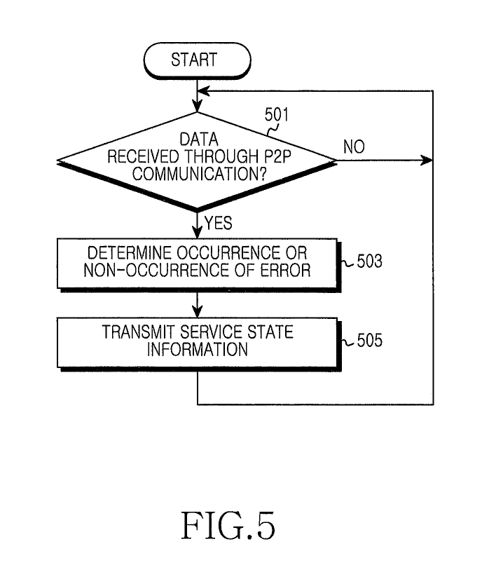

FIG. 5 illustrates a procedure for feeding back service state information in an external output device according to embodiments of the present disclosure.

Referring to FIG. 5, in step 501, the external output device determines if image data is received from an electronic device through short-range wireless communication.

If receiving the image data from the electronic device through the short-range wireless communication, the external output device proceeds to step 503 and determines the occurrence or non-occurrence of an error of the image data. For example, the external output device determines the occurrence or non-occurrence of the error in consideration of a CRC of the image data received from the electronic device.

After determining the occurrence or non-occurrence of the error of the image data, the external output device proceeds to step 505 and transmits service state information to the electronic device. For example, the external output device transmits service state information about each frame to the electronic device, using an extension region of the RTP standard.

The external output device repeatedly performs the aforementioned operations (steps 501 to 505) until the short-range wireless communication with the electronic device is ended.

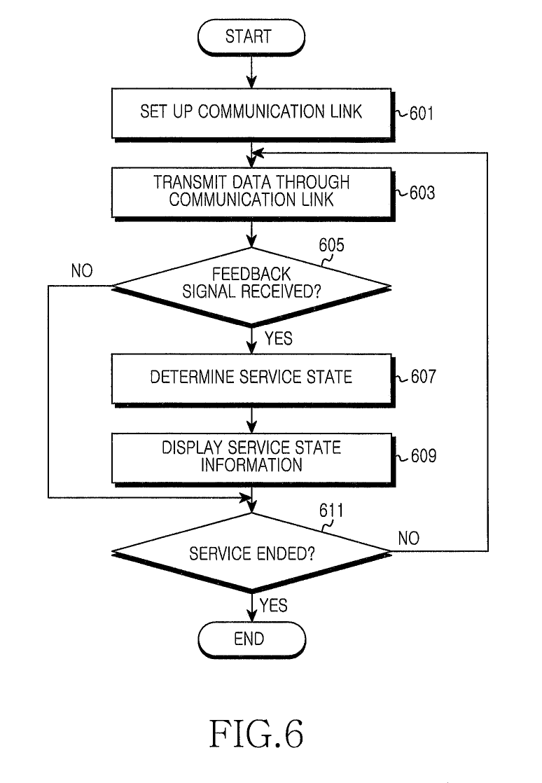

FIG. 6 illustrates a procedure for displaying service state information in an electronic device according to embodiments of the present disclosure.

Referring to FIG. 6, in step 601, the electronic device sets up a short-range wireless communication link with an external output device. For example, the electronic device searches an external output device for short-range wireless communication connection. If the external output device for the short-range wireless communication connection is searched, the electronic device establishes the short-range wireless communication connection with the external output device. After that, the electronic device performs a performance search and session establishment procedure with the external output device with which the connection is established.

After setting up the short-range wireless communication link with the external output device, the electronic device proceeds to step 603 and transmits image data to the external output device through the short-range wireless communication link.

Next, the electronic device proceeds to step 605 and determines if a feedback signal is received from the external output device. For example, the electronic device determines if service state information is received from the external output device.

If the feedback signal is not received from the external output device during a reference time, the electronic device jumps to step 611 and determines if a short-range wireless communication service with the external output device is ended.

On the other hand, if the feedback signal is received from the external output device, the electronic device proceeds to step 607 and determines state information about a service provided to the external output device, in the feedback signal received from the external output device. That is, the electronic device determines the occurrence or non-occurrence of an error of the image data transmitted to the external output device, through the service state information received from the external output device.

After determining the state information about the service provided to the external output device, the electronic device proceeds to step 609 and displays the service state information on a display unit. For example, if an error does not occur in the image data transmitted to the external output device, as illustrated in FIG. 9A, the electronic device displays normal service state information 900 in a partial region of a service screen. For another example, if the error occurs in the image data transmitted to the external output device, as illustrated in FIG. 9B, the electronic device can display service error information 910 and guidance information 912 for error improvement. For further example, if an error by interference occurs in the image data transmitted to the external output device, as illustrated in FIG. 9C, the electronic device can display service error information 920 and interference occurrence information 922.

Next, the electronic device proceeds to step 611 and determines if the short-range wireless communication service with the external output device is ended.

If the short-range wireless communication service with the external output device is not ended, the electronic device returns to step 603 and transmits image data to the external output device through the short-range wireless communication link.

On the other hand, if the short-range wireless communication service with the external output device is ended, the electronic device can terminate the algorithm of the present disclosure.

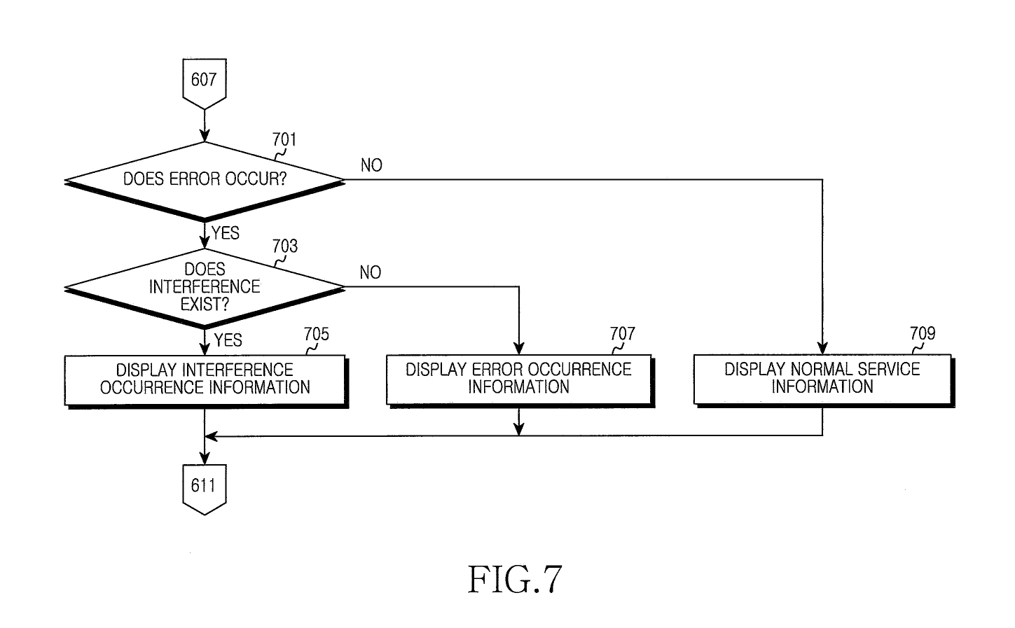

As described above, the electronic device displays on the display unit 260 the service state information about the image data, received from the external output device. At this time, the electronic device can display on the display unit 260 the service state information about the image data, received from the external output device, as illustrated in FIG. 7 below.

FIG. 7 illustrates a detailed procedure for displaying service state information in an electronic device according to embodiments of the present disclosure.

Referring to FIG. 7, in step 607 of FIG. 6, the electronic device determines state information about a service provided to an external output device. Next, the electronic device proceeds to step 701 and determines if an error occurs in image data transmitted to the external output device.

If the error does not occur in the image data transmitted to the external output device in step 701, the electronic device proceeds to step 709 and displays normal service state information on the display unit 260. For example, as illustrated in FIG. 9A, the electronic device displays normal service state information 900 in a partial region of a service screen.

Next, the electronic device proceeds to step 611 of FIG. 6 and determines if a short-range wireless communication service with the external output device is ended.

On the other hand, if the error occurs in the image data transmitted to the external output device in step 701, the electronic device proceeds to step 703 and determines if interference by other communication signals occurs. For example, the electronic device determines if interference in short-range wireless communication occurs owing to a WLAN communication signal with an Access Point (AP).

If the interference by the other communication signals occurs in step 703, the electronic device recognizes that an error occurs in the image data transmitted to the external output device owing to the interference by the other communication signals. According to this, the electronic device proceeds to step 705 and displays interference occurrence information on the display unit 260. For example, as illustrated in FIG. 9C, the electronic device can display service error information 920, and guidance information 922 guiding that the error has been occurred due to the interference.

Next, the electronic device proceeds to step 611 of FIG. 6 and determines if the short-range wireless communication service with the external output device is ended.

On the other hand, if the interference by the other communication signals does not occur in step 703, the electronic device recognizes that the error occurs in the image data transmitted to the external output device owing to radio jamming caused by a shield. According to this, the electronic device proceeds to step 707 and displays error occurrence information, i.e., guidance information for error improvement on the display unit 260. For example, as illustrated in FIG. 9B, the electronic device can display service error information 910, and guidance information 912 guiding to change a location of a terminal so as to avoid the radio jamming caused by the shield.

Next, the electronic device proceeds to step 611 of FIG. 6 and determines if the short-range wireless communication service with the external output device is ended.

In the aforementioned embodiment, the electronic device displays the service state information and the guidance information for error improvement.

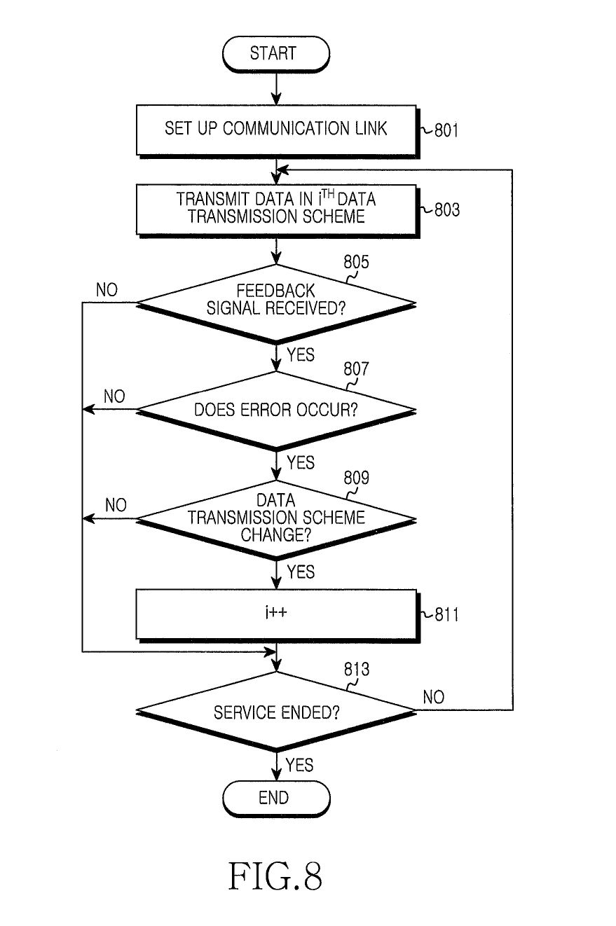

In another embodiment, the electronic device can change a data transmission scheme for the sake of error improvement and transmit image data according to the changed data transmission scheme, as illustrated in FIG. 8 below.

FIG. 8 illustrates a procedure for improving a service quality in an electronic device according to embodiments of the present disclosure.

Referring to FIG. 8, in step 801, the electronic device sets up a short-range wireless communication link with an external output device. For example, the electronic device searches an external output device for short-range wireless communication connection. If the external output device for the short-range wireless communication connection is searched, the electronic device establishes a connection for short-range wireless communication with the external output device. Next, the electronic device performs a performance search and session establishment procedure with the external output device with which the connection is established.

After establishing the short-range wireless communication link with the external output device, the electronic device proceeds to step 803 and transmits image data to the external output device through the short-range wireless communication link, according to an data transmission scheme. For example, the electronic device transmits the image data at a resolution of 1080 pixels (p) according to a 1st data transmission scheme. Here, the ‘i’ indicates an index for distinguishing the data transmission schemes stored in the data storage unit 212, and has ‘1’ as an initial value.

After that, the electronic device proceeds to step 805 and determines if a feedback signal is received from the external output device. For example, the electronic device determines if service state information is received from the external output device.

If the feedback signal is not received from the external output device during a reference time in step 805, the electronic device jumps to step 813 and determines if a short-range wireless communication service with the external output device is ended.

On the other hand, if the feedback signal is received from the external output device in step 805, the electronic device proceeds to step 807 and determines the occurrence or non-occurrence of an error of the image data provided to the external output device, in the feedback signal received from the external output device.

If the error does not occur in the image data provided to the external output device in step 807, the electronic device jumps to step 813 and determines if the short-range wireless communication service with the external output device is ended. In this case, as illustrated in FIG. 9A, the electronic device can display on the display unit 260 normal service state information 900 in a partial region of a service screen.

On the other hand, if the error occurs in the image data provided to the external output device in step 807, the electronic device proceeds to step 809 and decides whether to change the data transmission scheme. For example, if the error occurs in the image data provided to the external output device, as illustrated in FIG. 9D, the electronic device displays on the display unit 260 service state information 930 and a pop-up window 932 for deciding whether to change the data transmission scheme. If the selection of a “YES” 934 region of the pop-up window 937 is sensed through the input device 270, the electronic device recognizes that it changes the data transmission scheme. On the other hand, if the selection of a “NO” 936 region of the pop-up window 932 is sensed through the input device 270, the electronic device can recognize that it does not change the data transmission scheme.

When not changing the data transmission scheme in step 809, the electronic device jumps to step 813 and determines if the short-range wireless communication service with the external output device is ended. In this case, as illustrated in FIG. 9B or FIG. 9C, the electronic device can display guidance information 912 or 922 for error improvement according to the non-occurrence or occurrence of interference.

On the other hand, when changing the data transmission scheme in step 809, the electronic device proceeds to step 811 and changes the data transmission scheme. That is, the electronic device increases the index (i) of the data transmission scheme by one level. If the index of the data transmission scheme used for transmitting the image data is equal to a maximum value (i_{MAX}) in step 803, the electronic device can change the index (i) of the data transmission scheme into the initial value.

After that, the electronic device proceeds to step 813 and determines if the short-range wireless communication service with the external output device is ended.

If the short-range wireless communication service with the external output device is not ended in step 813, the electronic device returns to step 803 and transmits image data to the external output device through the short-range wireless communication link, according to the i^{th} data transmission scheme. For example, when changing the data transmission scheme in step 809, the electronic device scales down the image data to a resolution of 720 pixels according to a 2nd data transmission scheme, and transmits the scaled image data to the external output device.

On the other hand, if the short-range wireless communication service with the external output device is ended in step 813, the electronic device can terminate the algorithm of the present disclosure.

It will be appreciated that embodiments of the present disclosure according to the claims and description in the specification can be realized in the form of hardware, software or a combination of hardware and software. Any such software can be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software can be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described above, embodiments of the present disclosure have an advantage of being able to provide a user of an electronic device with a state of a service provided to an external output device and being able to improve a quality of the service provided to the external output device, by determining state information of the service provided to the external output device by means of a feedback signal received from the external output device through short-range wireless communication in an electronic device.

While the disclosure has been described with reference to certain preferred embodiments thereof, it will be understood by those skilled in the art that various changes in form and details may be made therein without departing from the spirit and scope of the disclosure as defined by the appended claims.

What is claimed is:

1. A method for providing service quality information in an electronic device, the method comprising:
transmitting image data to an external output device;
determining the occurrence or non-occurrence of an error in transmitting the image data; and
displaying on a display unit the occurrence or non-occurrence of the error.

2. The method of claim 1, further comprising:
before the operation of transmitting the image data, setting up a communication link with the external output device using short-range wireless communication that comprises at least one of Wireless Fidelity (WiFi) direct, Wireless Local Area Network (WLAN), ZigBee, and Infrared Data Association (IrDA),
wherein the operation of transmitting the image data comprises the operation of transmitting the image data to the external output device through the communication link.

3. The method of claim 2, wherein determining the occurrence or non-occurrence of the error comprises:
receiving a feedback signal from the external output device through the communication link; and
determining the occurrence or non-occurrence of the error in transmitting the image data using the feedback signal.

4. The method of claim 3, wherein the feedback signal comprises information about the occurrence or non-occurrence of an error of each frame using an extension region of the Real-time Transport Protocol (RTP) standard.

5. The method of claim 1, wherein displaying on the display unit comprises:
if an error does not occur in the image data, displaying a normal service information icon on the display.

6. The method of claim 1, wherein the operation of displaying on the display unit comprises the operation of, if the error occurs in the image data, displaying at least one of an error occurrence icon and an error occurrence guidance message on the display unit.

7. The method of claim 6, wherein the operation of displaying on the display unit further comprises:
when the error occurs in the image data, determining if interference occurs from a communication service other than a communication service with the external output device;
when the interference does not occur, displaying an error occurrence icon and a request message for change of a location of the electronic device on the display unit; and
when the interference occurs, displaying an error occurrence icon and an interference occurrence notification message on the display.

8. The method of claim 1, further comprising an operation:
after determining the occurrence or non-occurrence of the error of the image data, changing a data transmission scheme, when the error occurs in the image data.

9. The method of claim 8, wherein the data transmission scheme comprises resolution information for transmitting the image data.

10. The method of claim 1, wherein the operation of transmitting the image data comprises operations of:
transmitting the image data to the external output device; and
displaying on the display unit the image data transmitted to the external output device.

11. An electronic device for providing service quality information, comprising:
a communication unit configured to transmit and receive communication signals;
a display unit configured to display; and
at least one processor configured to execute computer programs,
wherein the processor is configured to transmit image data to an external output device using the communication system, determine the occurrence or non-occurrence of an error of the image data, and display on the display unit the occurrence or non-occurrence of the error of the image data.

12. The device of claim 11, wherein the communication unit is configured to set up a communication link with the external output device using short-range wireless communication comprising at least one of Wireless Fidelity (WiFi) direct, Wireless Local Area Network (WLAN), ZigBee, and Infrared Data Association (IrDA), and transmit the image data to the external output device through the communication link.

13. The device of claim 12, wherein the processor is configured to determine the occurrence or non-occurrence of the error of the image data, in a feedback signal received from the external output device through the communication link.

14. The device of claim 13, wherein the feedback signal comprises information about the occurrence or non-occurrence of an error of each frame using an extension region of the Real-time Transport Protocol (RTP) standard.

15. The device of claim 11, wherein, if an error does not occur in the image data, the processor is configured to display a normal service information icon on the display unit.

16. The device of claim 11, wherein, if the error occurs in the image data, the processor is configured to display at least one of an error occurrence icon and an error occurrence guidance message on the display unit.

17. The device of claim 16, wherein, when the error occurs in the image data, the processor is configured to determine if interference occurs from a communication service other than a communication service with the external output device, and when the interference does not occur, the processor is configured to display an error occurrence icon and a request message for change of a location of the electronic device on the display unit, and when the interference occurs, the processor is configured to display an error occurrence icon and an interference occurrence notification message on the display unit.

18. The device of claim 11, wherein, after determining the occurrence or non-occurrence of the error in transmitting the image data, the processor is configured to change a data transmission scheme, when the error occurs in the image data.

19. The device of claim 18, wherein the data transmission scheme comprises resolution information for transmitting the image data.

20. The device of claim 11, wherein the processor is configured to display on the display unit the image data transmitted to the external output device using the communication system.
